(19) United States
(12) Patent Application Publication
(10) Pub. No.: US 2002/0088323 A1
(43) Pub. Date: Jul. 11, 2002

(54) Device and method for cutting web

(75) Inventor: Yoshiyuki Hashigaya, Shizuoka-ken (JP)

Correspondence Address: SUGHRUE MION, PLLC, Suite 800, 2100 Pennsylvania Avenue, N.W., Washington, DC, 20037-3213, US

(73) Assignee: FUJI PHOTO FILM CO., LTD.

(21) Appl. No.: 10/035,162

(22) Filed: Jan. 4, 2002

(30) Foreign Application Priority Data
Jan. 11, 2001 (JP) 2001-3832

(51) Int. Cl. B26D 1/62

(52) U.S. Cl. 83/38; 83/324; 83/369

(57) ABSTRACT

A structure in which length-measuring roll including an elastic body is rotated by movement of a continuously fed web is employed, an amount of deformation of the length-measuring roll changes according to changes in a web speed, and a circumference of the length-measuring roll changes as a result. An error is generated in length measurement of the web, and therefore, web cutting accuracy by a cutter cannot be maintained. Therefore, timing of cutting by the cutter is controlled according to a fed length of the web and web speed information to maintain web cutting accuracy.

### BACKGROUND OF THE INVENTION

1. Field of the Invention

The present invention relates to a device and method for cutting a web of a photosensitive planographic printing plate precursor, or the like, to a predetermined size.

2. Description of the Related Art

Generally, for producing a photosensitive planographic printing plate precursor (hereinafter referred to as a “PS plate”), a sheet-like or coil-like aluminum plate is subjected to a surface treatment or a suitable combination of surface treatments such as graining, anodic oxidation, chemical conversion treatment. Then, the aluminum plate is coated with a photosensitive solution and dried (hereinafter, a product thus processed is called a “web”), and then cut to a desired size.

That is, a trimming width (width size) of a PS plate is determined by continuously cutting the web using a slitter. Then, a cutting length L (length in a conveyance direction) of the PS plate 12A is determined by continuous cutting by a flying shear 50, shown in FIG. 8, disposed at a downstream side of the slitter.

Timing of cutting by the flying shear 50 (timing of rotation) is controlled by measuring, with an encoder 56, the number of rotations of a length-measuring roll 54, which feeds a web 12, and calculating a fed length of the web 12 in a cutter controller 58.

In recent years, in order to eliminate adverse effects on a surface of the PS plate 12A, rubber rolls have been used for the length-measuring roll 54 instead of metal rolls that measure more accurately. However, as shown in FIG. 9, circumferences of rubber rolls 60 change because deformation conditions at a nip portion of the rubber rolls 60 change slightly depending on a speed of travel of the web 12.

Therefore, although the number of rotations of the rubber rolls 60 is constant, measured lengths of the web 12 vary depending on the speed of the web 12, and this causes irregularities in accuracy of the cut lengths of PS plate.

### SUMMARY OF THE INVENTION

In view of the aforementioned drawbacks, a task of the present invention is to become able to ensure accurate cutting even when a web speed changes.

A device for cutting a web according to a first aspect of the present invention comprises: a roll comprising an elastic body, the roll being rotatably mounted in contact with a web and rotating when the web is fed past the roll due to contact between the web and roll; a cutter for cutting the web disposed downstream of the roll relative to feed direction of the web; a length-measuring device for measuring length of the web fed past the roll; and a controller which communicates with the cutter and the length-measuring device and receiving the information from the length-measuring device, with the controller controlling timing of cutting by the cutter according to fed length of the web and web speed information based on data from the length-measuring device.

In the above-described structure, since the rolls having elastic bodies (hereinafter, elastic rolls) are rotated by the movement of the continuously fed web, there is no risk of damaging the surface of the web, as there is when metal rolls are used. However, an amount of crushing of the elastic rolls changes according to changes in the web speed, and the circumferences of the elastic rolls change.

Since the length-measuring device measures the fed length of the web by counting the number of rotations of the elastic rolls, errors are generated in a measurement of the length of the web, and therefore, accurate cutting of the web (hereinafter, web cutting accuracy) cannot be maintained.

Therefore, the controller controls the timing of cutting by the cutter on the basis of the fed length of the web and the web speed information, thereby maintaining accurate web cutting.

The device for cutting a web according to the present invention is preferably characterized in that the web speed information includes acceleration/deceleration information of the web, based on data received from the length-measuring device at a time of previous cutting and at a time of current cutting.

In the structure described above, whether the web is in a state of acceleration or deceleration is continuously determined on the basis of a web speed at a time of previous cutting and a web speed at a time of current cutting to ensure web cutting accuracy.

Further, the device for cutting a web according to the present invention is preferably characterized in that the timing of cutting by the cutter is controlled so as to compensate for errors in length measurement according to hysteresis of acceleration and deceleration, the hysteresis of acceleration and deceleration being the acceleration/deceleration information.

In the structure described above, the different changed states of the circumference of the elastic rolls according to hysteresis of acceleration and deceleration of the web are noted. Then, since errors in length measurement of the web can be accurately understood, web cutting accuracy can be improved.

Furthermore, the device for cutting a web according to the present invention is preferably characterized in that the controller controls the timing of cutting by the cutter by correcting a set cutting length value of the web on the basis of a correction value obtained by multiplying the web speed, a cutting length of the web, and a correction coefficient together.

In the structure described above, the fact that errors in the measurement of the cutting length by the elastic rolls become larger when the cutting length becomes larger is noted, and the timing of cutting by the cutter is controlled so that a set cutting length of the web which is input to the controller is controlled using a correction value calculated by multiplying a cutting length of the web.

In addition, the device for cutting a web according to the present invention is preferably characterized in that the controller controls the timing of cutting by the cutter by correcting a set cutting length value of the web on the basis of at least one of a correction value obtained by multiplying the web speed, a unit length of the web, and a correction coefficient together, and a correction value obtained by multiplying the web speed, a circumference of the roll and a correction coefficient together.

In the structure described above, all cutting lengths from long to short can be swiftly corrected on the basis of the web measurement errors.

A method for cutting a web according to another aspect of the present invention comprises the steps of: (a) feeding the web past a rotatably mounted roll comprising an elastic body, with the roll contacting the web so that the roll rotates due to contact between the roll and the web, (b) measuring fed length and speed information of the web based on rotation of the roll; and (c) cutting the web so as to compensate for an error in the fed length measured which error varies according to the speed information of the web.

### BRIEF DESCRIPTION OF THE DRAWINGS

FIG. 1 is a perspective view showing all of a line in which a device for cutting a web according to an embodiment of the present invention is used.

FIG. 2 is a block diagram for explaining the device for cutting a web according to the embodiment of the present invention.

FIG. 3 is a graph showing a relationship between hysteresis at times of acceleration and deceleration of the web and errors in cutting length.

FIG. 4 is a flow chart showing a procedure for calculating correction values.

FIG. 5 is a graph showing differences between errors in cutting length of the web when the correction has been performed and when the correction has not been performed.

FIG. 6 is a graph showing amounts of errors due to differences in set cutting lengths of the web when the correction has not been performed.

FIG. 7 is a graph showing amounts of errors due to differences in set cutting lengths of the web when the correction has been performed.

FIG. 8 is a block diagram for explaining a conventional device for cutting a web.

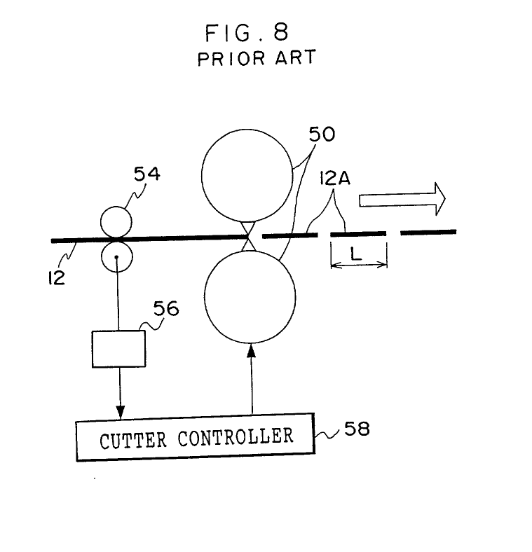

FIG. 9 is a sectional view showing an aspect of deformation of rubber rolls due to changes in speed.

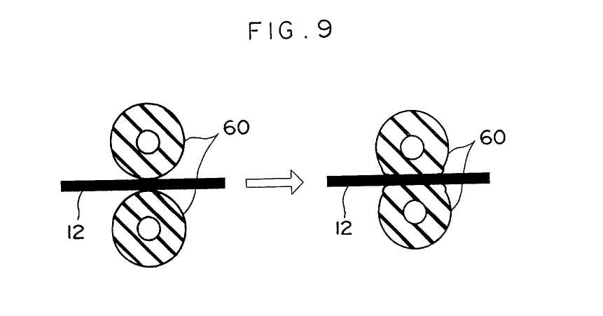

### DESCRIPTION OF THE PREFERRED EMBODIMENTS

Hereinafter, an embodiment of the present invention will be described with reference to the figures.

First, an outline of a cutting line will be described.

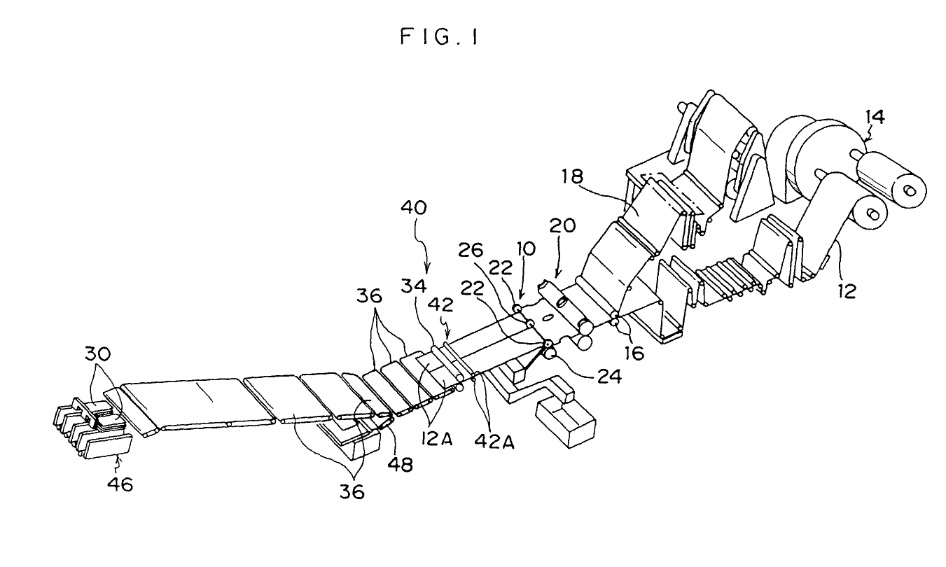

As shown in FIG. 1, a feeding device 14 for feeding a roll-shaped web 12 is disposed at an upstream side of a processing line. The web 12 is fed from the feeding device 14, and then, a charged interleaf sheet 18 is superposed on the web 12 at feeding rolls 16. Then, the web 12 is conveyed to a notcher 20.

The notcher 20 punches holes in edge portions or a central portion of the web 12 so that upper trimming blades 22 and lower trimming blades 24 of a slitter 10 can move in a width (transverse) direction of the web 12 at the punched portions. Thus, trimming widths (width sizes) of the web 12 can be changed during continuous cutting (cutting the interleaf sheet and the web). Further, as necessary, the web 12 may be cut and divided down the central portion thereof by a center-cutting blade 26 to form two webs.

In this manner, the web 12 is trimmed to a predetermined trimming width. Then, a length-measuring roll 42 of a web-cutting device 40A detects a fed length of the web, and a cutter 34 cuts the web 12 with an instructed timing to produce PS plates 12A having a set size.

The PS plates 12A are loaded onto a conveyer 36 and conveyed to a collecting site 46. Then, after a predetermined number of the PS plates 12A which were conveyed to the collecting site 46 are piled up, the PS plates are packaged in, for example, a corrugated board box to be shipped. Defective products sorted by a sorting device 48 are conveyed to a dumping site by an ejection conveyer 48.

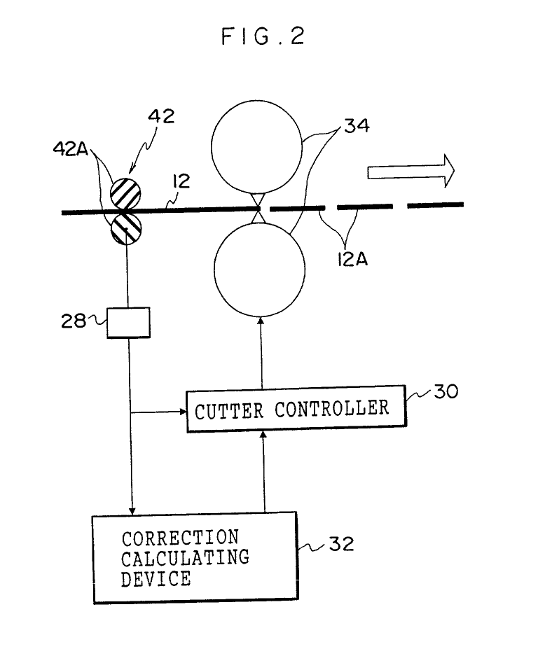

Next, the web-cutting device will be described with reference to FIG. 2.

The length-measuring roll 42 comprises rubber roll portions 42A as elastic bodies, which nip the web 12 from the upper side and the lower side and which are rotated by movement of the web 12. By making portions of the rolls contacting the web 12 out of rubber, there is no risk of damaging the surface of the web 12.

An encoder 28 is attached at a shaft of the length-measuring roll 42. By counting pulses of the encoder 28 using a counter, a rotation angle (the number of rotations) of the length-measuring roll 42 can be measured.

Based on this, a fed amount of the web 12 from the length-measuring roll 42 is calculated by the cutter controller 30, and the cutter 34 is rotated at a predetermined timing on the basis of a cutting length of an inputted product size to cut the web 12 continuously.

However, when the above-described control method is used, the web 12 cannot be cut to a correct product size since a circumference of the length-measuring roll 42 changes depending on the speed of the web 12. Therefore, a correction calculation device 32 is provided for continuously correcting irregularities in cutting accuracy due to changes in the speed of the web 12, so that accuracy of cutting can be ensured in any speed range and in any state of acceleration or deceleration.

Specifically, a current web speed is calculated on the basis of length-measuring pulses input to the correction calculation device 32 from the encoder 28. By comparing the current speed with a previously measured speed, namely, a speed measured at the time of previous cutting, it is determined whether the web 12 is in a state of acceleration, constant speed, or deceleration.

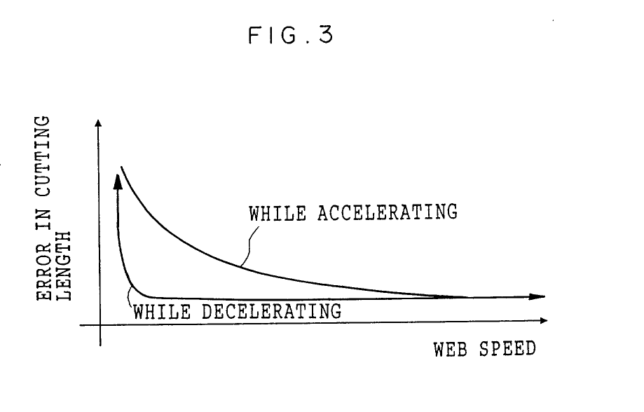

As shown in FIG. 3, a determination of the state of the web speed is carried out because errors in the cutting length with respect to the set cutting value vary due to hysteresis at the times of acceleration and deceleration. Therefore, the set cutting value which is input to the cutter controller 30 is corrected using a correction value according to each state of the speed. Thus, timing of cutting by the cutter 34 is modified.

The correction calculation is given by:

α=(A·v+B)x×

where α is a correction value, v is a web speed, x is a cutting length of a product size, a correction coefficient A=−4.56939×10⁻⁶, and a correction coefficient B=3.55513×10⁻⁴.

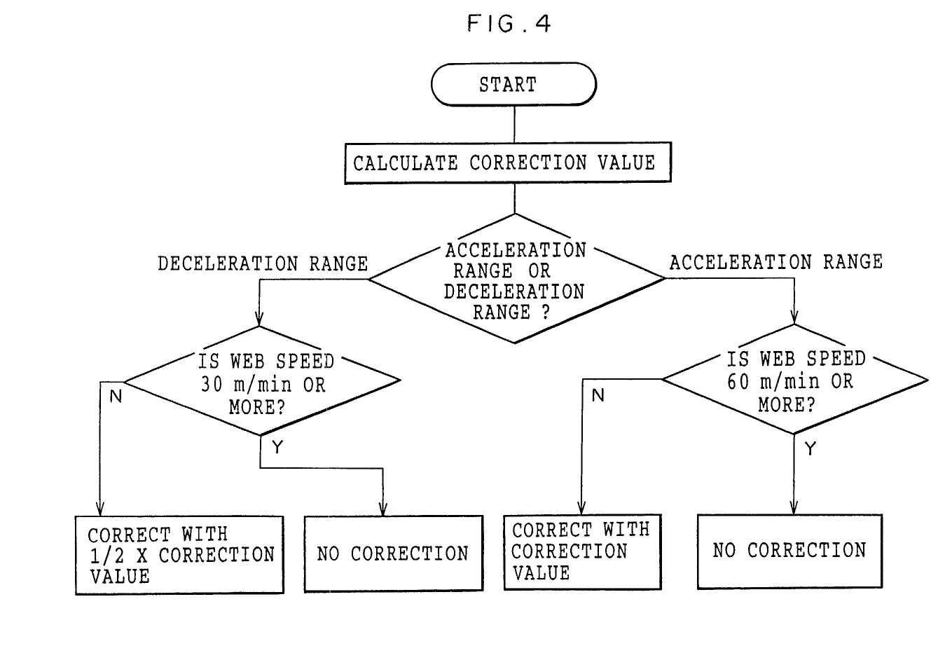

Note that, as shown in FIG. 4, when the web speed is less than 60 m/min and accelerating or at a constant speed, (x+α) is input to the cutter controller 30 as a set cutting value. However, when the web speed is 60 m/min or more and decelerating or at a constant speed, x is input to the cutter controller 30 as a set cutting value without correction.

Further, when the web speed is less than 30 m/min and in the deceleration range, (x+α/2) is input to the cutter controller 30 as a set cutting value, and when the web speed is 30 m/min or more and in the deceleration range, x is input to the cutter controller 30 as a set cutting value without correction.

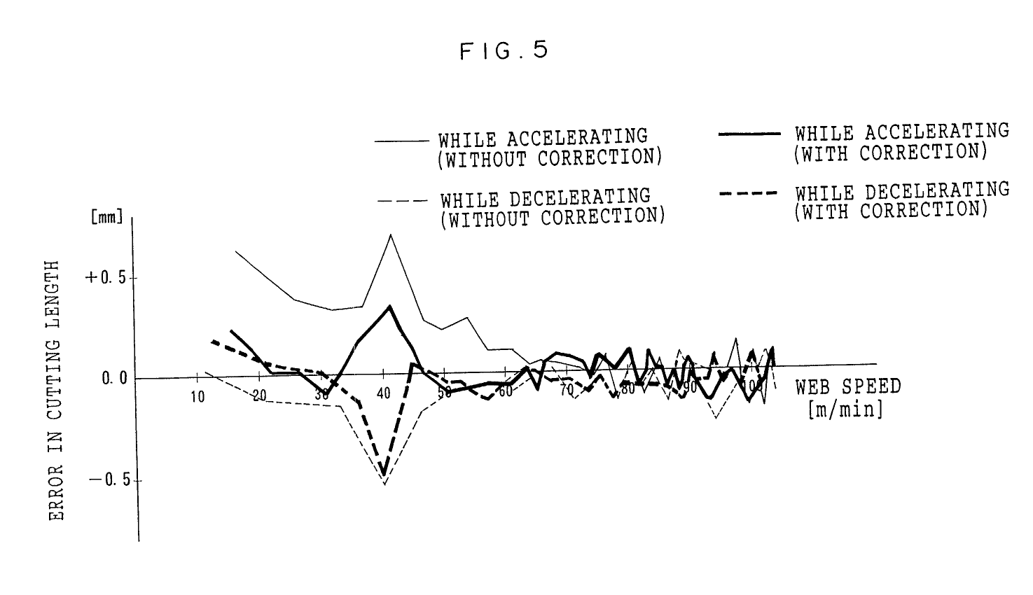

The reason why the correction of the set cutting value differs between these cases can be seen from results of an experiment shown in FIG. 5. When the web is in the acceleration range and correction is not performed, errors in the cutting length are large at the web speed of less than 60 m/min. Therefore, the boundary of whether the correction is performed or not is around the web speed of 60 m/min.

On the other hand, when the web is in the deceleration range and the web speed is less than 30 m/min, errors are smaller than those are when the web is in the acceleration range. Therefore, one half of a calculated correction value is used as a correction value. Further, when the web speed is 30 m/min or more, errors are small except around the web speed of 40 m/min. Therefore, correction is not performed.

In addition, errors generated by using the rubber length-measuring roll 42 are caused by changes in the circumference of the length-measuring roll 42. Therefore, if the cutting length is doubled, even if the error per unit of length is the same, the absolute value of the error will become twice as large.

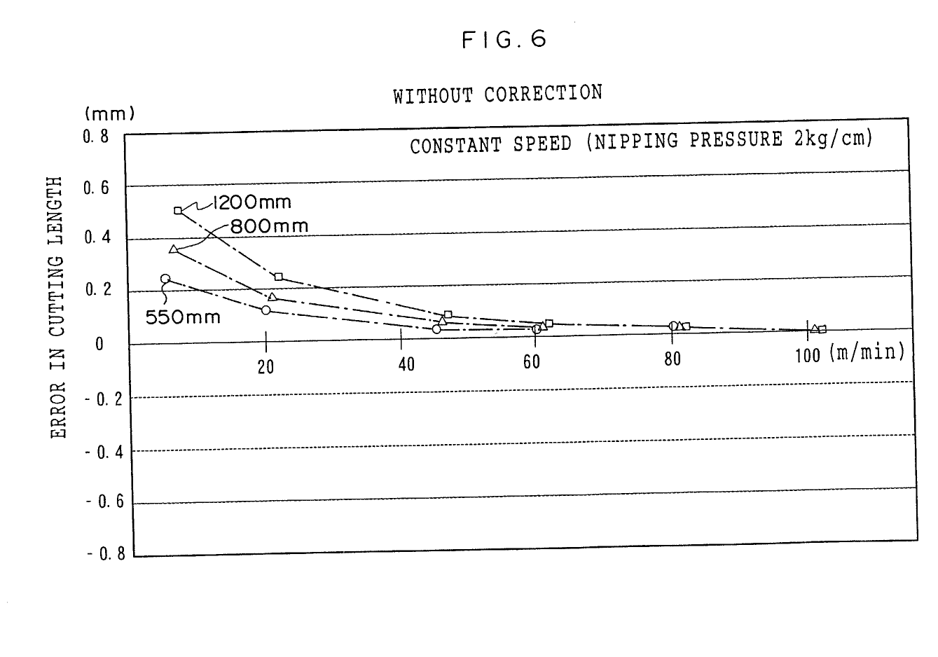

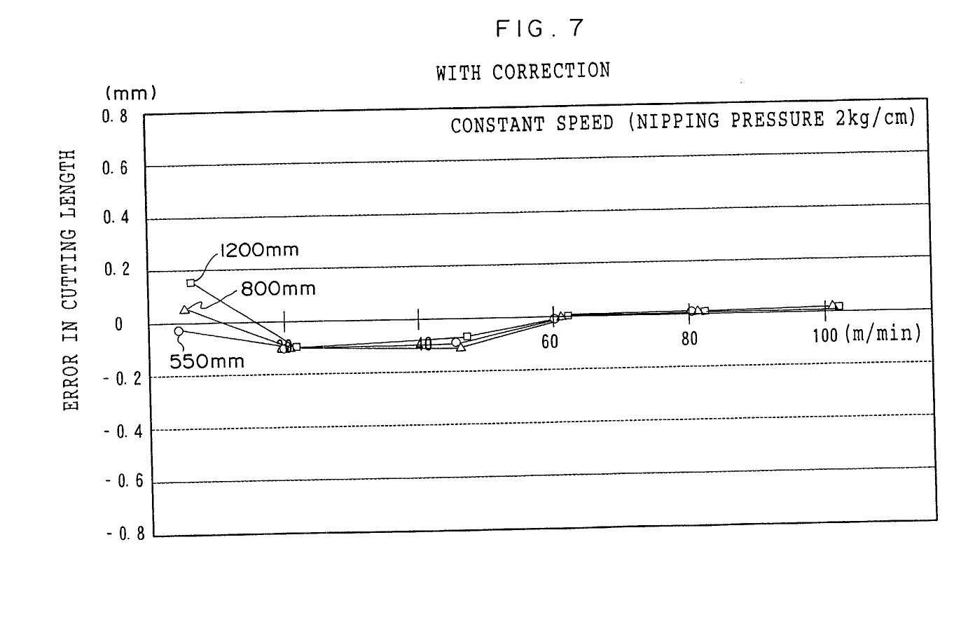

FIGS. 6 and 7 are graphs showing dimensional errors when the set cutting value has not been corrected and when it has been corrected, respectively. As can be seen from the graphs, as the length of the PS plate increases to 550 mm, 800 mm and 1200 mm, the dimensional error also increases.

Accordingly, if a correction value per unit of cutting length or a correction value per single rotation of the length-measuring roll is calculated, a correction value for a set cutting length can be calculated on the basis of the correction value for the unit cutting length or the correction value per rotation of the length-measuring roll.

As described above, in the present embodiment, by continuously correcting irregularities in accuracy of cutting due to the web speed, accuracy of cutting required for products can be ensured in all speed ranges from a speed immediately after the line starts operation to a maximum web speed, and from the maximum web speed to the speed when the line stops operation.

Further, although the description has been made based on PS plates in the present embodiment, the printing plate may be of a type with which image recording is carried out using a laser beam, such as a CCP printing plate. The present invention can be applied to all products that are produced by cutting a long sheet to a set size.

Since the present invention has the above-described structure, it is less likely to damage the web, and it can ensure accuracy of cutting even when the web speed changes.

What is claimed is:

1. A device for cutting a web, the device comprising:
a roll comprising an elastic body, the roll being rotatably mounted in contact with a web and rotating when the web is fed past the roll due to contact between the web and roll;
a cutter for cutting the web disposed downstream of the roll relative to feed direction of the web;
a length-measuring device for measuring length of the web fed past the roll; and
a controller which communicates with the cutter and the length-measuring device and receiving the information from the length-measuring device, with the controller controlling timing of cutting by the cutter according to fed length of the web and web speed information based on data from the length-measuring device.

2. The device for cutting a web according to claim 1, wherein the web speed information includes acceleration/deceleration information of the web, based on data received from the length-measuring device at a time of previous cutting and at a time of current cutting.

3. The device for cutting a web according to claim 2, wherein the timing of cutting by the cutter is controlled so as to compensate for errors in length measurement according to hysteresis of acceleration and deceleration, the hysteresis of acceleration and deceleration being the acceleration/deceleration information.

4. The device for cutting a web according to claim 3, wherein the controller controls the timing of cutting by the cutter by correcting a set cutting length value of the web on the basis of a correction value obtained by multiplying the web speed, a cutting length of the web, and a correction coefficient together.

5. The device for cutting a web according to claim 3, wherein the controller controls the timing of cutting by the cutter by correcting a set cutting length value of the web on the basis of at least one of a correction value obtained by multiplying the web speed, a unit length of the web, and a correction coefficient together, and a correction value obtained by multiplying the web speed, a circumference of the roll and a correction coefficient together.

6. A method for cutting a web to a set cutting length, the method comprising the steps of:
(a) feeding the web past a rotatably mounted roll comprising an elastic body, with the roll contacting the web so that the roll rotates due to contact between the roll and the web,
(b) measuring fed length and speed information of the web based on rotation of the roll; and
(c) cutting the web so as to compensate for an error in the fed length measured which error varies according to the speed information of the web.

7. The method for cutting a web according to claim 6, wherein the speed information of the web includes acceleration/deceleration information measured from web speed at a time of previous cutting and web speed at a time of current cutting.

8. The method for cutting a web according to claim 7, wherein the step of cutting the web includes controlling timing of cutting by a cutter so as to compensate for the error in length measurement according to hysteresis of acceleration and deceleration, the hysteresis of acceleration and deceleration being the acceleration/deceleration information.

9. The method for cutting a web according to claim 7, wherein the step for cutting the web includes controlling timing of cutting by a cutter by correcting a set cutting length of the web on the basis of a correction value obtained by multiplying the web speed, a cutting length of the web, and a correction coefficient together.

10. The method for cutting a web according to claim 9, wherein the set cutting length of the web is corrected when the web speed is in one of an acceleration range and a constant speed range and the web speed is less than to a certain speed, and the set cutting length of the web is not corrected when the web speed is in one of the acceleration range and the constant speed range and the web speed at least equal to the certain speed.

11. The method for cutting a web according to claim 10, wherein the certain speed is 60 m/min.

12. The method for cutting a web according to claim 10, wherein the set cutting length of the web is corrected when the web speed is in a deceleration range and the web speed is less than to another certain speed, and the set cutting length of the web is not corrected when the web speed is in the deceleration range and the web speed at least equal to the another certain speed.

13. The method for cutting a web according to claim 12, wherein the another certain speed is 30 m/min.

14. The method for cutting a web according to claim 13, wherein the correction value used when the web speed in the deceleration range is one half of that used when the web speed is in one of the acceleration range and in the constant speed range.

15. The method for cutting a web according to claim 7, wherein the step of cutting the web includes controlling timing of cutting by a cutter by correcting a set cutting length of the web on the basis of one of a correction value obtained by multiplying the web speed, a cutting length of the web and a correction coefficient together, and a correction value obtained by multiplying the web speed, a circumference of the roll and a correction coefficient together.
